(19) United States
(12) Patent Application Publication
(10) Pub. No.: US 2009/0021504 A1
(43) Pub. Date: Jan. 22, 2009

(54) Display apparatus integrated with power line communication function

(76) Inventors: Chi-Kun Oh Yang, Hsinchu City (TW); Wen Tai Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/898,222

(22) Filed: Sep. 11, 2007

(30) Foreign Application Priority Data
Jul. 19, 2007 (TW) 096211793

(51) Int. Cl. G06F 3/00; G09G 5/00

(52) U.S. Cl. 345/211; 710/301

(57) ABSTRACT

A display apparatus integrated with power line communication function includes a port, a power line communication module, a signal processing controller, a displayer and a display driving module. The port is for connecting a device that stores or provides a digital image data. The power line communication module includes a power supply unit and a network connecting port, and the power supply unit obtains the operating power of the display apparatus from a power line, and the network connecting port connects a network apparatus through the power line for carrying out data transmission. The digital image data processed and outputted by the signal processing controller is displayed by the display driving module and the displayer.

### BACKGROUND OF THE INVENTION

1. Field of the Invention

The present invention relates to a display apparatus, and more particularly to a display apparatus obtaining an operating power and with data communication capability through power line.

2. Description of the Related Art

As digital image apparatus becomes increasingly popular, more and more users digitize various images by using a digital camera or a scanner to facilitate the storage of a large quantity of digital images. In addition, users can also share digital images with their relatives and friends through file transmission or network download regardless of their distance apart, and such application is much more convenient than those of the photos or pictures of traditional media. The electronic device capable of displaying the digital image can read a digital image file from a memory card, or connect the electronic apparatus capable of storing or providing a digital image file, such as a computer, a scanner or a digital camera, and convert the digital image file into a data that can be accepted by the display driving module, and show the digital image on the displayer. If a user wants to connect to a network, he/she must request a telecommunication company to assign a technical staff to install a network cable at the user's home, then the user connect an electronic device to a modem so that the electronic device can connect to the Internet through the modem. Besides, the electronic device also requires a power supply device for supplying electric power. The requirement of both power supply device and network cable is still not convenient for user. Thus, finding a way of simplifying the application for supplying power to an electronic device and connecting a network demands immediate attentions and feasible solutions.

In view of the drawbacks of the prior art, the inventor of the present invention based on years of experience in the related industry to conduct extensive researches and experiments, and finally developed a display apparatus integrated with power line communication function in accordance with the present invention to overcome the aforementioned drawbacks.

### SUMMARY OF THE INVENTION

Therefore, it is a primary objective of the present invention to provide a display apparatus integrated with power line communication function to achieve the effect of saving an additional layout of network cables or power cables.

To achieve the foregoing objective, the present invention provides a display apparatus integrated with power line communication function, comprising at least one interface port, a power line communication module, a signal processing controller, a displayer and a display driving module. The interface port connects to various equipments that store or provide digital image data. The power line communication module includes a power supply unit and a network connecting port, and the power supply unit obtains an operating power of the display apparatus from a power line, and the network connecting port connects a network apparatus through the power line, so that the display apparatus can perform data communication with the network apparatus through the power line. The signal processing controller is for processing an inputted digital image data, and controlling the playback way of the inputted digital image data. The displayer is for displaying digital image data, and the display driving module is for driving the displayer to display the data processed by the signal processing controller.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

FIG. 1 is a block diagram of a display apparatus integrated with power line communication function in accordance with the present invention;

FIG. 2 is a block diagram of a display apparatus integrated with power line communication function of a preferred embodiment in accordance with the present invention; and

FIG. 3 is a block diagram of network configuration of a display apparatus integrated with power line communication function of a preferred embodiment in accordance with the present invention.

### DETAILED DESCRIPTION OF THE PREFERRED EMBODIMENTS

In the related figures of preferred embodiments of a display apparatus integrated with power line communication function in accordance with the present invention, the same referring numerals are used for the same components in accordance with the present invention.

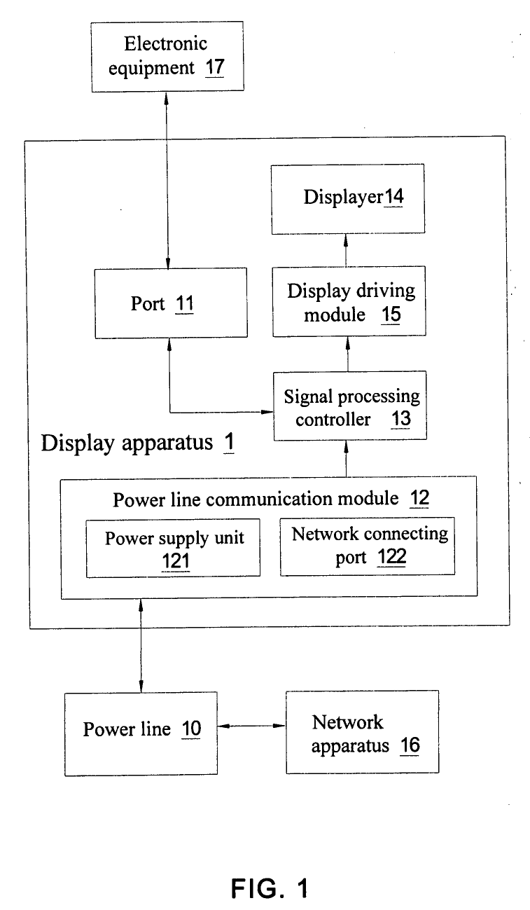

Please referring to FIG. 1 for a block diagram of a display apparatus integrated with power line communication function in accordance with the present invention, the display apparatus 1 comprises at least one transmission interface port 11, a power line communication module 12, a signal processing controller 13, a displayer 14 and a display driving module 15. The transmission interface port 11 is for connecting an electronic equipment 17 that stores or provides digital image data. An interface of the transmission interface port is preferably an RS232 interface, an USB interface, an USB OTG interface, an IEEE1394 interface, a PCMCIA interface, a computer image transmission line interface or an AV terminal, wherein the computer image transmission line interface, the AV terminal and RS232 interface are generally used for connecting a personal computer or a recording player, and the USB interface, the USB OTG interface, the IEEE1394 interface and the PCMCIA interface are generally used for connecting a personal computer, a digital camera, a digital camcorder, a scanner, and an external hard disk, etc.

The power line communication module 12 includes a power supply unit 121 and a network connecting port 123. When user connects the power line 10 with the display apparatus 1, the power supply unit 12 obtains electric power from the power line 10 for supplying an operating power to the display apparatus 1, and the network connecting port 122 is connected to a network apparatus 16 through the power line 10, such that the display apparatus 1 can perform data communication with the network apparatus 16 through the power line 10. The network apparatus 16 includes an electronic apparatus situated at an Intranet or the Internet, such as a computer or a server. The power line communication module 12 complies with various power line communication standards, such as the Homeplug standard.

The signal processing controller 13 is for processing an inputted digital image data, and controlling the playback way of the digital image data. The displayer 14 is for displaying data, and the display driving module 15 is for driving the displayer 14 to display the data processed by the signal processing controller 13. Preferably, the display apparatus 1 is a digital photo frame or a computer screen. When the display apparatus 1 is used as a computer screen which is connected to a computer system, the computer system connects to a network through this computer screen. If necessary, the display apparatus 1 can include a storage module for storing the inputted digital image data or a digital data received from the network apparatus. The storage module includes a hard disk, a flash memory or a storage memory. Preferably, the displayer 14 can be a cathode ray tube (CRT) screen, a liquid crystal display (LCD), an OLED displayer or a plasma display panel (PDP).

If necessary, the display apparatus 1 can include a memory card slot which is applied to connect a memory card for reading digital data from the memory card. Preferably, the memory card specification that the memory card slot supports includes smart digital card (SD card), compact flash card (CF card), memory stick (MS card), smart media card (SM card) or multi-media card (MM card), etc.

The signal processing controller 13 can control the playback way of data. For instance, if the signal processing controller 13 identifies more than one file stored in a data source device, then the display driving module 15 will switch these images dynamically over a predetermined time interval, such as switching a displayed digital image file to another selected digital image file once every half an hour. The signal processing controller 1 is preferably a microprocessor or a microcontroller.

When processing an inputted digital image data, the signal processing controller 13 will determine whether or not the inputted digital data is in a displayable image file format, such as BMP file, GIF file, JPG file, PNG file or TIF file, or in a displayable video format, such as MPEG file, AVI file, WMV file or ASF file. Then the signal processing controller 13 processes the files according to various property of files to convert inputted digital data into signals that can be processed by the display driving module 15 and display the data on the displayer 14.

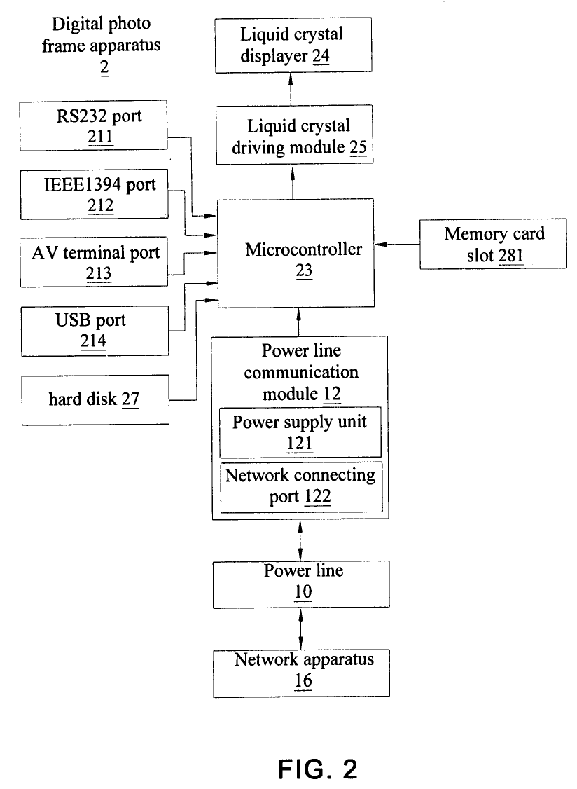

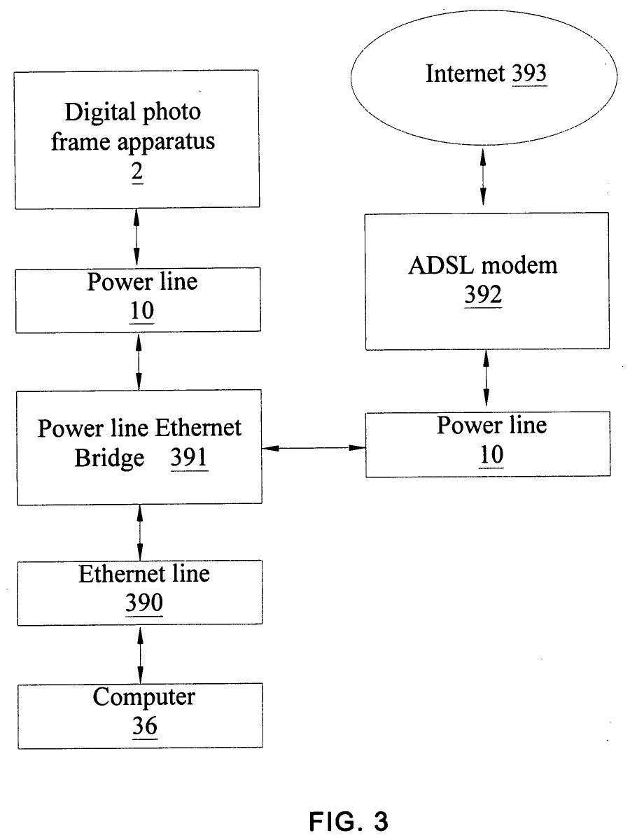

Please referring to FIG. 2 for a block diagram of a display apparatus integrated with power line communication function in accordance with a preferred embodiment of the present invention, the digital photo frame apparatus 2 is an embodiment of the display apparatus and comprises a plurality of ports 211˜214, a power line communication module 12, a microcontroller 23, a liquid crystal displayer 24, a liquid crystal driving module 25, a hard disk 27 and a memory card slot 281. The digital photo frame apparatus 2 is characterized by transmitting data with a network apparatus 16 through a power line 10, so that the cost and complexity for installing the network cable can be lowered, as shown in FIG. 3. Referring to the FIG. 3 for network configuration of power line communication system, an ADSL modem 392 is for transmitting data to the internet 393 and connected to a power line ethernet bridge 391 via the power line 10, and the computer 36 is connected to the power line ethernet bridge 391 via ethernet line 390. With the power line communication module 12, the digital photo frame apparatus 2 can communicate with the electronic apparatus in the internet 393 or the computer 36 after plugging with the power line 10 only. The user can replace the ADSL modem 392 with a Cable modem or other common modem. The memory card slot 281 may comprise a CF card slot, a PCMCIA card slot, an SD card slot, an MS card slot, an SM card slot or an MM card slot, etc.

Users can insert a memory card containing a digital image file into an appropriate memory card slot, and then the microcontroller 23 identifies the file format of the digital image file in the memory card and converts the digital image file into signals that can be processed by the liquid crystal driving module 25, and then the image corresponding to the digital image file can be displayed on the liquid crystal displayer 24. Users can also connect an electronic apparatus that stores or provides a digital image file to an appropriate port (one of the ports 211˜214), and then the microcontroller 23 obtains the digital image file from the electronic apparatus and converts the digital image file into signals that can be processed by the liquid crystal driving module 25 and the image corresponding to the digital image file will be displayed on the liquid crystal displayer 24. Users also can store a digital image file from a memory card, an electronic apparatus or a network apparatus 16 into a hard disk 27 to facilitate viewing the images anytime.

While the present invention has been described by way of examples and in terms of preferred embodiments, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A display apparatus integrated with power line communication function, comprising:
at least one interface port, for connecting various types of equipments that store or provide digital data;
a power line communication module, connected to power line, and comprising a power supply unit for obtaining an operating power of the display apparatus from the power line, and a network port for connecting a network apparatus through the power line and performing data communication between the display apparatus and the network apparatus through the power line;
a signal processing controller, for processing the inputted digital image data, and controlling a playback way of the digital image data;
a displayer, for displaying the digital image data; and
a display driving module, for driving the displayer to display the data processed by the signal processing controller.

2. The display apparatus of claim 1, further comprising at least one memory card slot, for connecting a memory card to read a digital data stored in the memory card.

3. The display apparatus of claim 2, wherein the memory card slot supports a memory card specification including smart digital card (SD card), compact flash card (CF card), memory stick (MS card), smart media card (SM card) or multi-media card (MM card).

4. The display apparatus of claim 1, wherein the displayer is a cathode ray tube (CRT) screen, a liquid crystal display (LCD), an OLED displayer or a plasma display panel (PDP).

5. The display apparatus of claim 1, wherein the transmission interface port supports an interface at least including an RS232 interface, an USB interface, an USB OTG interface, an IEEE1394 interface or a PCMCIA interface.

6. The display apparatus of claim 1, wherein the transmission interface port supports an interface including a computer image transmission line interface or an AV terminal.

7. The display apparatus of claim 1, wherein the signal processing controller has a function of dynamically switching digital images.

8. The display apparatus of claim 1, further comprising a storage module, for storing the inputted digital image data or a digital data received from the network apparatus.

9. The display apparatus of claim 8, wherein the storage module comprises a hard disk driver device, a flash memory or a storage memory.

10. The display apparatus of claim 1, wherein the power line communication module complies with various kinds of power line communication standards.

11. The display apparatus of claim 1, wherein the display apparatus is a digital photo frame or a screen.
